(19) United States
(12) Patent Application Publication
(10) Pub. No.: US 2008/0317436 A1
(43) Pub. Date: Dec. 25, 2008

(54) DIGITAL SIGNAL RECORDER WITH SELECTIVE ENCRYPTION AND KEY GENERATION

(76) Inventors: Manabu SASAMOTO, Yokohama (JP); Makoto AIKAWA, Yokohama (JP); Hiroo OKAMOTO, Yokohama (JP); Takaharu NOGUCHI, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/202,587

(22) Filed: Sep. 2, 2008

Related U.S. Application Data
(63) Continuation of application No. 09/913,595, filed on Oct. 22, 2001.

(51) Int. Cl. H04N 5/91

(52) U.S. Cl. 386/95

(57) ABSTRACT

A digital signal recorder for recording a digital signal on a recording medium, including: an input circuit which receives a transmitted digital signal encrypted for protecting said transmitted digital signal using a first encryption method; a decrypting circuit which decrypts said transmitted digital signal into an original data; a key generation circuit which performs a prescribed arithmetic operation to generate a key; an encrypting circuit which receives said key and said original data, and encrypts said original data with said key using a second encryption method; a recording circuit which records, onto said recording medium, a key information which is used for decrypting said encrypted digital signal together with said encrypted digital signal, and a timing control circuit which controls decrypting timing of said decrypting circuit and encryption timing of said encrypting circuit; wherein said key generation circuit has a function for updating said key in connection with recording units of said recording media.

### CROSS REFERENCE TO RELATED APPLICATION

This is a continuation of U.S. application Ser. No. 09/913,595, filed Oct. 22, 2001. The entirety of the contents and subject matter of all of the above is incorporated herein by reference.

### BACKGROUND OF THE INVENTION

This invention relates to a digital signal recorder, reproducer and recording medium; and, more particularly, the invention relates to a recorder, reproducer, and recording medium having the capability of protecting the copyrights of digital data on a recording medium.

Research has been conducted in recent years on the compression of data, such as video and audio data which employ digital technology, so that it has become easy to store and transmit such data. In conjunction therewith, digitization is also rapidly moving forward in the field of broadcasting.

Systems are known, for example, which are capable of very efficiently converting analog video signals to compressed digital code, using the MPEG (Moving Picture Experts Group) standard, and of transmitting the compressed digital signals via satellite or coaxial cables. A digital broadcast receiver, called a set top box, is available as an apparatus for receiving these digital broadcasts.

In the field of video and audio signal recording and reproducing equipment, advances are being made in the development of digital VTRs that, using magnetic tape, can record and reproduce video and audio signals that have been converted to compressed digital code, such as digital TV broadcasts, in their digital signal form.

The digital broadcast receiver and digital VTR mentioned here are connected by a digital interface, making it possible to save received digital broadcasts without sacrificing their high quality.

Technology in which a transmitted digital signal is received, in which a plurality of information is multiplexed, and from which a desired program is selected has been described in Japanese Patent Application Laid-Open No. H8-56350/1996. And, a digital VTR that uses a rotary magnetic head is described, for example, in Japanese Patent Application Laid-Open No. H5-174496/1993.

Also, a digital broadcast recording system wherein a digital broadcast receiver and a digital VTR are connected by a digital interface is described in detail in “Newly Developed D-VHS Digital Tape Recording System for the Multimedia Era,” IEEE Transactions on Consumer Electronics, Volume. 42, No. 3, August, 1996, pp 617-622.

Nevertheless, no consideration whatever has been given in the prior art to copyright protection for digital signals recorded on a recording medium by a digital VTR or the like from a digital broadcast or the like.

An object of the present invention is to protect the copyrights of digital signals on a recording medium.

### SUMMARY OF THE INVENTION

In accordance with the present invention, a digital signal recorder for recording a digital signal on a recording medium, at the recording time, encrypts the digital signal with a key obtained by subjecting key information to a prescribed arithmetic operation, and records the digital signal together with the key information on the recording medium; and, at the reproducing time, a digital reproducer decrypts the reproduced digital signal with a key obtained by subjecting the key information reproduced from the recording medium to the prescribed arithmetic operation.

### BRIEF DESCRIPTION OF THE DRAWINGS

FIG. 1 is a block diagram showing a configuration comprising a digital broadcast receiver and a digital signal recorder-reproducer representing an embodiment of the present invention;

FIG. 2 is a block diagram showing configuration of a digital signal recorder and reproducer 200 of FIG. 1;

FIG. 3 is a diagram showing the configuration of a compressed digital video signal packet;

FIG. 4 is a diagram showing the configuration of the packet header 306 of FIG. 3;

FIGS. 5(a) and 5(b) are diagrams showing configurations of a digital broadcast transmission signal and of a signal selected from a transmission signal, respectively;

FIG. 6 is a block diagram showing the configuration of the data encryption circuit 115 of FIG. 2;

FIG. 7 is a block diagram showing the configuration of the encrypter 1155 of FIG. 6;

FIGS. 8(a) and 8(b) are functional diagrams showing the generation of data keys in a control circuit 104 which represent cases of the generation of data keys sent to the data encryption circuit 115 and the data decryption circuit 116 of FIG. 2;

FIG. 9 is a diagram of a recording pattern on 1 track in a tape 111;

FIG. 10 is a diagram showing the configuration of a block in the data recording area 7 of FIG. 9;

FIG. 11 is a diagram showing the configuration of the ID information 21 of FIG. 10;

FIG. 12 is a diagram showing the configuration of 1 track of data in the data recording area 7 of FIG. 9;

FIG. 13 is a diagram showing the configuration of blocks in 1 packet when a compressed digital video signal transmitted in a 188-byte packet format is recorded in the data 41 of FIG. 12;

FIG. 14 is a diagram showing the configuration of the header 44 for the data recording area 7 of FIG. 12;

FIG. 15 is a diagram showing the configuration of pack data when information area 47 of FIG. 14;

FIG. 16 is a diagram illustrating a method of holding block keys;

FIG. 17 is a diagram illustrating another method of holding block keys;

FIG. 18 is a diagram showing a specific configuration of the time information 25 of FIG. 13;

FIG. 19 is a block diagram showing the configuration of the data decryption circuit 116 of FIG. 2;

FIG. 20 is a block diagram showing the configuration of a digital recording and reproducing signal processing circuit 102 comprising the recording signal processing circuit 102a and the reproducing signal processing circuit 102b of FIG. 2;

FIG. 21 is a timing chart for signal processing when data recording is started;

FIG. 22 is a diagram of key information in the tape 111 indicated in FIG. 2;

FIG. 23 is a timing chart for signal processing when reproducing data; and

FIG. 24 is a block diagram of another configuration of the digital signal recorder-reproducer 200 indicated in FIG. 1.

### DESCRIPTION OF THE PREFERRED EMBODIMENTS

An embodiment of the present invention will now be described with reference to the drawings.

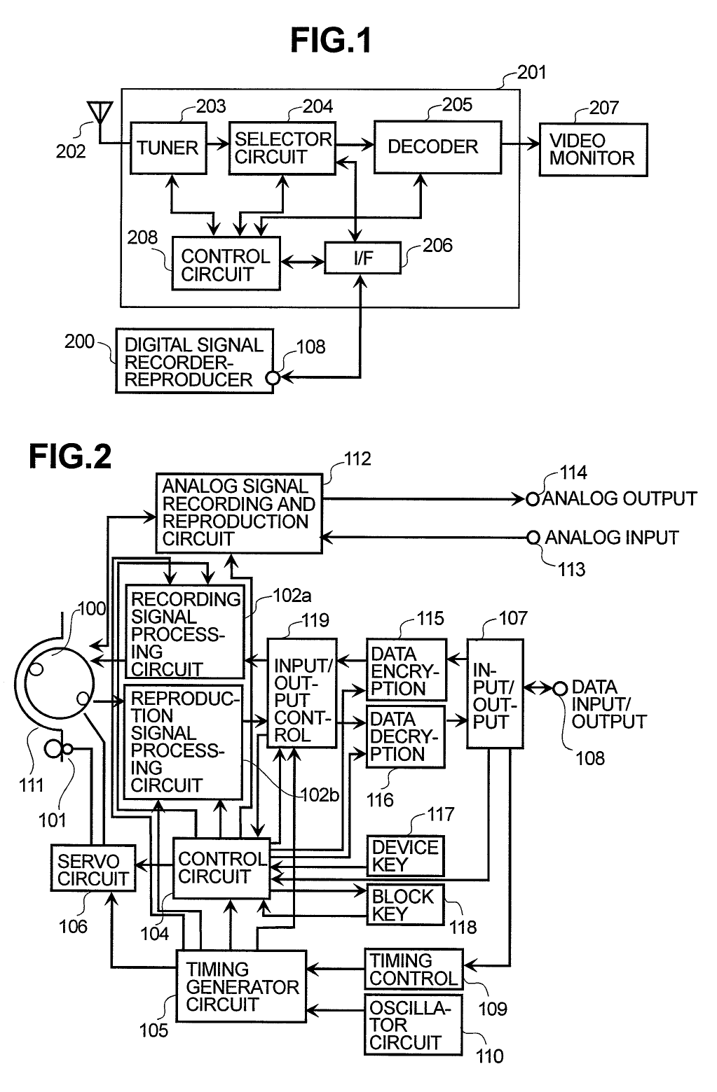

FIG. 1 is a diagram of a configuration comprising a digital broadcast receiver 201 and a digital signal recorder-reproducer 200. The digital broadcast receiver 201 is connected to an antenna 202 and to a video monitor 207. Moreover, the digital broadcast receiver 201 comprises a tuner 203, a selector circuit 204, a decoder 205, an interface circuit 206, and a control circuit 208 for controlling the operation of the digital broadcast receiver 201. The digital-broadcast receiver 201 and the digital signal recorder-reproducer 200 here are represented as separate units, but these may be integrated into a single unit.

FIG. 2 is a block diagram showing the configuration of the digital signal recorder-reproducer 200 of FIG. 1. FIG. 2 shows an apparatus that is used for both recording and reproducing, but there will be no difference if recording and reproducing are made independent. The digital signal recorder-reproducer 200 comprises a rotary head 100, a capstan 101, is a recording signal processing circuit 102a for performing such operations as the generation of recording signals when recording, a reproducing signal processing circuit 102b for performing such operations as the demodulation of reproducing signals when reproducing, a control circuit 104 such as a microprocessor, for example, for controlling recording and reproducing modes, etc., a timing generator circuit 105 for generating a timing signal that becomes a reference for the turning of the rotary head 100, etc., a servo circuit 106 for controlling the rotary head and the feed speed of tape, an input/output circuit 107 for inputting recording signals and outputting reproducing signals, a timing control circuit 109 for controlling timing when recording, an oscillator 110 for generating a reference clock signal, a tape 111, an analog video signal recording and reproducing circuit 112, a data encryption circuit 115 used when recording a digital signal, a data decryption circuit 116 used when reproducing a digital signal, a device key generator 117 for generating device keys that become a basis for data keys sent to a data encryption circuit 115 or data decryption circuit 116 when encrypting or decrypting digital information, a block key generator 118 for generating block keys that become another basis for data keys when encrypting or decrypting digital information, and an input/output control circuit 119 for performing a time stamping routine when recording and performing packet data output control when reproducing.

Compressed digital video signals are transmitted as packet-formatted data wherein signals of multiple channels are time-division multiplexed. In FIG. 1, a digital broadcast signal received by the antenna 202 is demodulated by the tuner 203, after which a necessary compressed digital video signal is selected by the selector circuit 204. The selected compressed digital video signal is decoded by the decoder 205 to an ordinary video signal and is output to the video monitor 207. When the received signal has been subjected to scrambling processing or the like, the signal is decoded after being descrambled in the selector circuit 204. When a received digital broadcast signal is recorded, the compressed digital, video signal to be recorded and information pertaining thereto are selected in the selector circuit 204, routed through the interface circuit 206, input through an input/output terminal 108 of the digital signal recorder-reproducer 200 to the digital signal recorder-reproducer 200, and recorded. When reproducing the recorded digital broadcast signal, the compressed digital video signal reproduced by the digital signal recorder-reproducer 200 is output from the input/output terminal 108 to the interface circuit 206. The compressed digital video signal input to the interface circuit 206 is subjected to the same kind of processing as during ordinary reception, by the selector circuit 204 and the decoder 205, and is output to the video monitor 207.

In FIG. 2, which shows the configuration of the digital signal recorder-reproducer 200 of FIG. 1, when recording data, part of the packet data input from the input/output terminal 108 is input via the input/output circuit 107 to the control circuit 104. In the control circuit 104, the packet data type and the like are detected from information that is added to the packet data packet data or information sent separately from the packet data, a recording mode is detected according to the detection results, and the operating mode of the recording signal processing circuit 102a and servo circuit 106 is set. Next, the input/output circuit 107 outputs the packet data to be recorded to the data encryption circuit 115. In the data encryption circuit 115, the input packet data are encrypted by a data key generated in the control circuit 104 based on keys generated by the device key generator 117 and the block key generator 118, and the encrypted data are output to the input/output control circuit 119. In the input/output control circuit 119, a time stamp is added in the packet data input, based on time information from the timing generator circuit 105, and the time-stamped packet data are output to the recording signal processing circuit 102a. In the recording signal processing circuit 102a, recording data comprising an error correction code, ID information, a sub-code, and block key information used in encrypting and the like, are generated, and a recording signal is generated, in accordance with the recording mode determined by the control circuit 104, and the data are recorded onto the tape 111 by the rotary head 100.

When reproducing data, a reproducing operation is first performed in any reproducing mode, and ID information is detected by the reproducing signal processing circuit 102b. A determination is then made in the control circuit 104 as to which mode the data was recorded in, the operating mode of the reproducing signal processing circuit 102b and servo circuit 106 is reset, and reproducing is performed. In the reproducing signal processing circuit 102b, from the reproducing signal reproduced by the rotary head 100, the synchronization signal detection, error detection and correction, and the acquisition of block key information and the like are performed, and the packet data are reproduced and output to the input/output control circuit 119. In the input/output control circuit 119, packet data from which the time stamp has been removed are output to the data decryption circuit 116, referencing the timing generated by the timing generator circuit 105. In the data decryption circuit 116, the packet data are decrypted by a data key generated in the control circuit 104, based on a key generated by the device key generator 117 and a block key obtained by the reproducing, and the data is output to the input/output circuit 107.

When recording data, the operational timing of the recorder-reproducer is controlled by the timing control circuit 109 based on the rate of the recording data input from the input/output terminal 108; and, when reproducing data, an operation is performed with a clock signal generated by the oscillator circuit 110 as the operational reference.

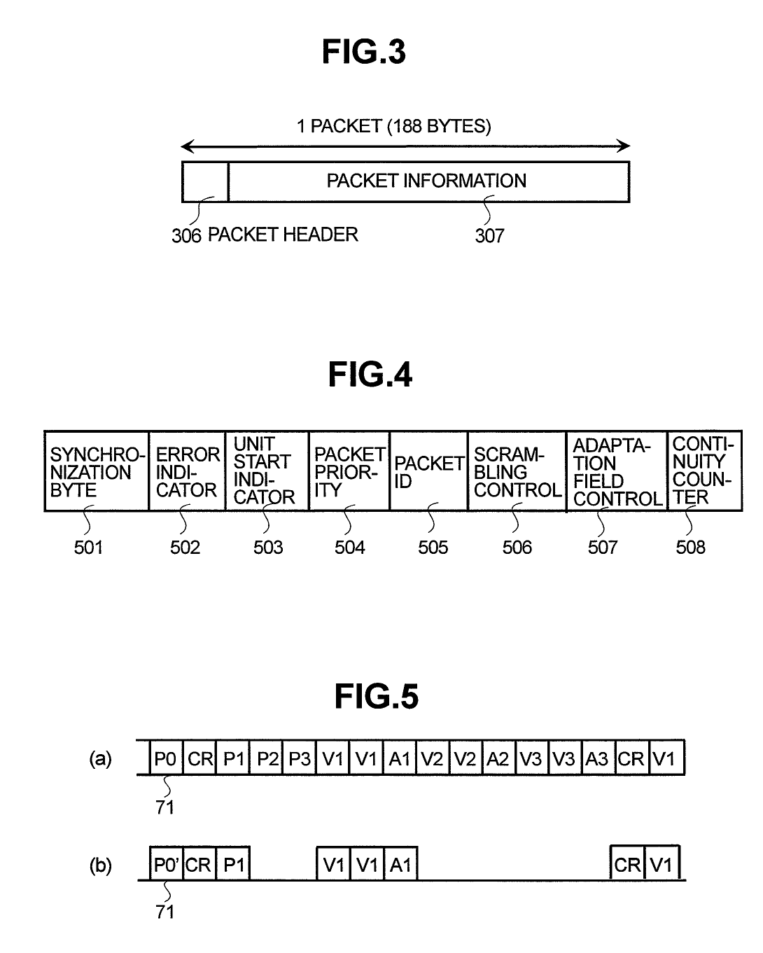

FIG. 3 is a diagram showing the configuration of a compressed digital video signal packet. Each packet is configured in a fixed length of, for example, 188 bytes, made up of a 4-byte packet header 306 and 184 bytes of packet information 307. The compressed digital video signal is deployed in the packet information area 307. The packet header 307 is made up of information, such as the packet information type.

FIG. 4 is a diagram of the packet header 306 shown in FIG. 3. Item 501 is a synchronization byte that indicates the head of the packet, item 502 is an error indicator indicating whether any errors are present, item 503 is a unit start indicator indicating the start of a unit, item 504 is a packet priority indicating the importance of the packet, item 505 is a packet ID indicating the packet type, item 506 is a scrambling control indicating whether scrambling has been effected, item 507 is an adaptation field control indicating whether there is added information and whether there is packet information present, and item 508 is a continuity counter that is incremented in packet units.

FIGS. 5(a) and 5(b) are diagrams showing configurations of a digital broadcast transmission signal and of a signal selected from a transmission signal, respectively. Item 71 is a packet as shown in FIG. 3. Ordinarily, an audio signal and program-related information and the like are added to the video signal noted above, and therein multiple channel programming is time-division multiplexed and transmitted.

FIG. 5(a) represents an example wherein three channels of programming are multiplexed, with V1, V2, and V3 respectively designating channel signals, and A1, A2, and A3 respectively designating channel audio signal packets. In some cases, the video or audio will be configured such that there will be multiple video or audio signals on one channel. P0, P1, P2, and P3 are information relating to programs. Each respective packet is assigned a different packet ID 505 whereby the packet content can be identified.

P0 is information relating to the overall transmission signal in FIG. 5(a), wherein packets containing a program association table for recognizing which packet IDs are assigned to the respective programs, and program guide information and the like, are time-division multiplexed and transmitted. P1, P2, and P3 are information relating to the prospective programs. Therein, packets are time-division multiplexed and transmitted, including a program map table for recognizing which packet IDs have been assigned to those video packets and audio packets and the like for those channels, and scramble information and the like. Ordinarily, a predetermined value, such as 0, for example, is assigned as the program association table packet ID.

When receiving data, which ID is assigned to the program map table, for the program to be received is first recognized by the program association table, and, next, which IDs are assigned to the video packet and audio packet and the like by the program map table for the program to be received is recognized. Then, the video packet and audio packet are extracted and the compressed digital data are decoded. Also, simultaneously therewith, a program clock reference is extracted, and thereby the operation of the decoder is controlled so that the compressed digital data decoding timing of the decoder is synchronized with the timing during encoding.

CR is program clock reference information for effecting synchronization when decoding the compressed digital data.

The number of multiplexed channels may be a number other than three, of course, so that there may be four channels, for example, and Information other than that may also be multiplexed.

In FIG. 5(b), only the first channel information and program information relating thereto have been selected from FIG. 5(a). When recording the first channel, that information is output from the digital broadcast receiver 201 to the digital signal recorder-reproducer 200. Information other than that may also be included in this recording, of course, and some of the packet information may be modified to facilitate easier processing when reproducing. If the program association table information is modified to only information for a program to be recorded, for example, at the reproducing time there will be no need to make a channel selection.

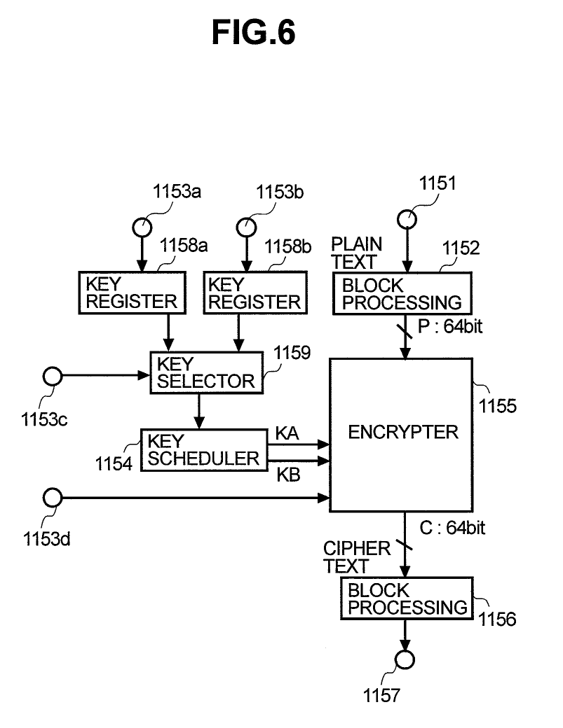

FIG. 6 is a block diagram of the data encryption circuit 115 of FIG. 2, which includes a packet data input terminal 1151, a packet data output terminal 1157, data key input terminals 1153a and 1153b, a data key selection signal input terminal 1153c, a processing mode selection signal input terminal 1153d, block processing circuits 1152 and 1156, a key schedule circuit 1154, an encrypted 1155, data key registers 1158a and 1158b, and a data key selector 1159. The data encryption circuit 115 encrypts and outputs input packet data units using a predetermined data key. When that is being done, the security of the packet data recorded on the tape can be enhanced by modifying that data key at some time interval.

The encrypter 1155 uses block encryption with which encryption processing can be achieved with a select configuration in units of blocks each made up of multiple bits, so that, even when an error such as a bit error occurs during transmission, that error will not affect data coming after it, that is, so that there will be no error propagation.

Packet data input from the input terminal 1151 are first divided into blocks P each made up of multiple bits in the block processing circuits 1152. Assume, for example, that one block has 64 bits. The blocks are sequentially encrypted in the encrypter 1155; as a result, blocks C are output, and then, in the block processing circuit 1156, the blocks are restored to the packet data format and output to the output terminal 1157. Here, the data keys, that are keys for performing encryption, as received from the control circuit 104, are input from the data key input terminals 1153a and 1153b, and stored in the data key registers 1158a and 1158b. In the data key register 1158a, for example, the current data key is recorded, and in the data key register 1158b the next data key to be switched is recorded.

From the data key selection signal input terminal 1153c, a signal is input, as received from the control circuit 104, indicating whether to select the data key in the data key register 1158a or 1158b, and the selected data key is output from the data key selector 1159. Let it be assumed here that the data key in the data key register 1158a has been selected, for example. The selected data key is converted to sub-keys KA and KB in the key schedule circuit 1154, and sent to the encrypter 1155. Assuming a data key length of 56 bits and a sub-key length of 32 bits, respectively, the high order 32 bits in the data key are assigned to KA, while the added value of the high order 32 bits and low order 32 bits of the data key is assigned to KB.

Here, when modifying the data key, a signal is input from the data key selection signal input terminal 1153c so as to output the contents of the data key register 1158b, by the control circuit 104. The data key selector effects control so that, until the encryption of all of the data blocks in one packet is finished, switching is carried out between this and the next packet data, without switching that selection output.

In addition thereto, there is also a method of making the cipher stronger by, for example, taking the exclusive-or of the output of the encrypter 1155 and the input of the encrypter 1155 and feeding those back in block units.

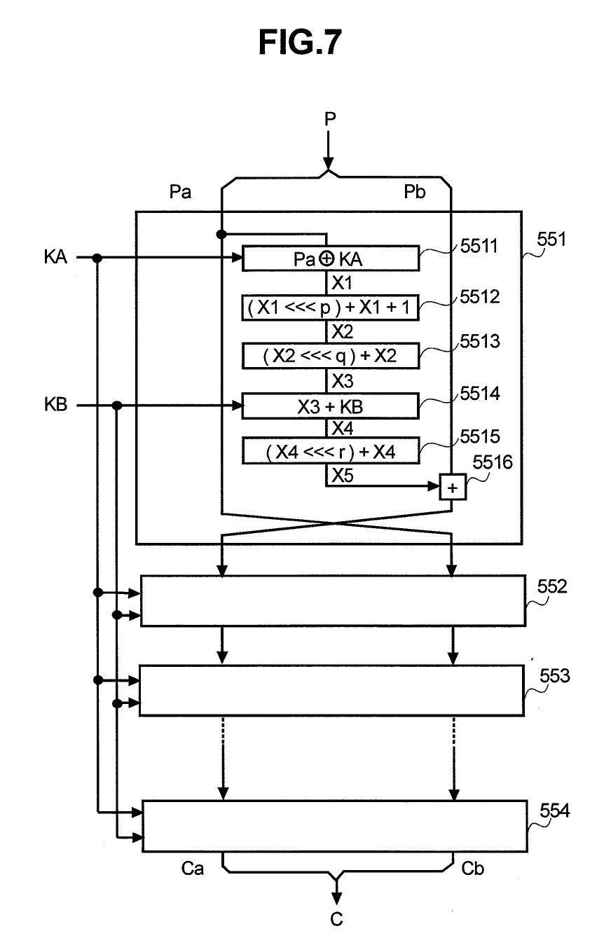

FIG. 7 is a configurational diagram of the encrypter 1155 of FIG. 6. In FIG. 7, items 551, 552, 553, and 554 are encryption processors, Pa and Pb denote the upper significant and lower significant bits in the input block data P. Ca and Cb denote encrypted data, and KA and KB denote sub-keys. As diagrammed in FIG. 7, the input 64-bit block P, for example, is separated into the high order 32 bits Pa and low order 32 bits Pb thereof. In the encryption processor 551, these bits Pa and Pb are subjected to exclusive-or processing (5511), bit shifts and addition operations (5512, 5513, 5515: A <<<p indicating that A is subjected to an end-around bit shift to the left), and adding operations (5514, 5516). The results are input to the following encryption processors 552 and 553 which perform the same processing as the encryption processor 551, and after that they are input to an encryption processor (not shown), and multiple-stage repetitive arithmetic processing is performed. Then, from the data Ca and Cb output by the encryption processor 554 in the final stage, the encrypted block C is obtained.

In the foregoing, the data encryption circuit 115 shown in FIG. 2 and FIG. 7 was described, but the encrypted block can be decrypted by performing operations in the reverse flow of the encrypter 1155, in the data decryption circuit 116. However, the operation 5516 in FIG. 7 is then carried out as a subtraction process. For the sub-keys KA and KB, the same keys must of course be used as when encrypting.

Besides that, there are also cases where, when there is no need to protect the packet data being recorded, such as in a case where a program being recorded is permitted to be freely copied, the packet data will be recorded on the tape as it is, without being encrypted. This can be accomplished by switching the data encryption circuit 115 and the data decryption circuit 116 from functions for encrypting and decrypting the input packets to functions at pass those packets without doing anything to them. In the data encryption circuit 115 shown in FIG. 2 and FIG. 6, by fixing the input X5 going to the operation 5516 indicated in FIG. 7 to zero, by a processing mode selection signal input via the processing mode selection signal input terminal 1153d indicated in FIG. 6, although that is not shown in the figures, a block can be made to pass through without performing encryption or decryption processing thereon. Based on this method, the operations can be switched while keeping the input packet processing delay time constant. There is also another method, moreover, not shown in the figures either, wherewith a switching circuit for switching to determine whether to output the packet data input from the packet data input terminal 1151 to the data output terminal 1157, without passing them through the block processing circuit 1152, encrypter 1155, or block processing circuit 1156, and whether to output the packet data output from the block processing circuit 1156 to the data output terminal 1157, is deployed in a stage in front of the data output terminal 1157, inputting the processing mode selection signal input via the processing mode selection signal input terminal 1153d to that switching circuit, and switching between packet data output from the block processing circuit 1156 and packet data input to the data output terminal 1157. These methods can be implemented also in the data decryption circuit 116 shown in FIG. 2 and FIG. 19, with the same kind of configuration as described earlier.

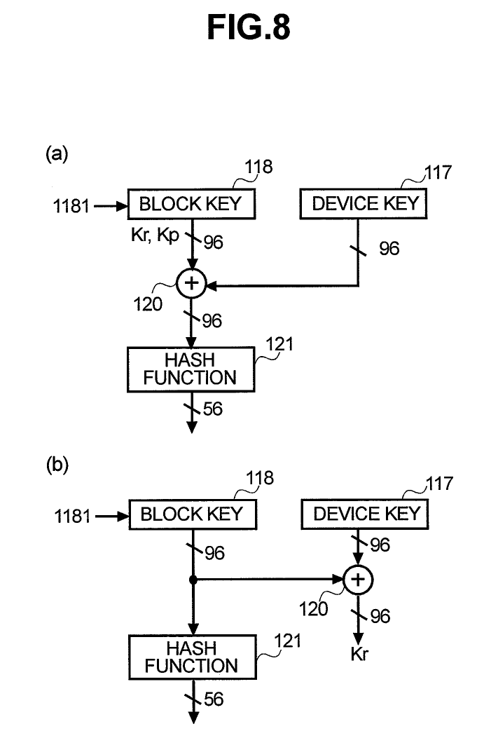

FIGS. 8(a) and 8(b) are diagrams showing the generation of data keys in a control circuit 104 which represent cases of the generation of data keys sent to the data encryption circuit 115 and the data decryption circuit 116 shown in FIG. 2. The device key generator 117 stores 96 bits of predetermined fixed key information, for example. The block key generator 118 is a random number generator that generates 96-bit random numbers at a command 1181 from the control circuit 104 shown in FIG. 2, for example. Item 120 is a 96-bit exclusive-or arithmetic processor, while item 121 is a hash function arithmetic processor. In FIG. 8(a), the block key and device key are subjected to an exclusive-or operation by the exclusive-or arithmetic processor 120, a hash operation is performed by the hash function arithmetic processor 121, and 56 bits selected from those results are sent as a data key to the data encryption circuit 115 shown in FIG. 2. The hash function is a function with which it is very difficult, from the results output thereby, to analogically infer the data input; while, from the data key, the block key and device key that are secret information cannot be found.

Also, by generating the d 1181 from the control circuit 104 of FIG. 2 at some time interval, and repeatedly forming the data key generation by the operations described above, the data key can be successively modified, making it possible to enhance the security of the data on the recording medium. Next, the block key (Kr) generated by the block key generator 118 is sent to the recording signal processing circuit 102a indicated in FIG. 2 and recorded on the tape 111.

When reproducing data, the same operations as described in the foregoing are performed, but, instead of the block key generated by the block key generator 118, a block key (Kp) reproduced from the tape 111 is used, whereupon a data key is obtained and sent to the data decryption circuit 116 indicated in FIG. 2.

FIG. 8(b) shows an example where the key information Kr recorded on the tape 111 is the exclusive-or of the block key and the device key. In this case, the block key itself is input to the hash function arithmetic processor. When reproducing data, the same operations as described in the foregoing are performed, but, instead of the block key indicated in FIG. 8(a), a block key Kp reproduced from the tape 111 is used, whereupon a data key is obtained and sent to the data decryption circuit 116.

The method of recording data on the tape will be described next.

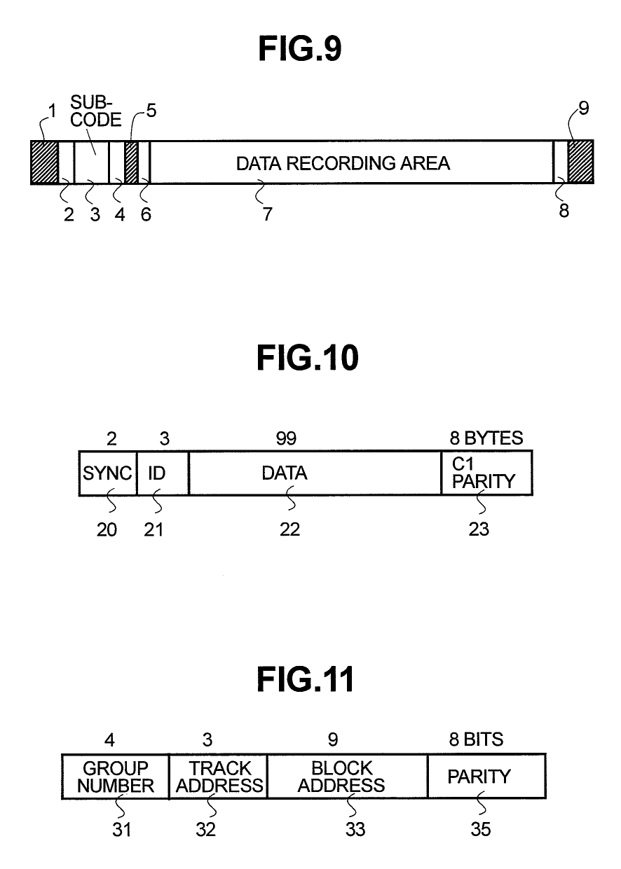

FIG. 9 is a diagram of a recording pattern for 1 track. Item 3 is a sub-code recording area for recording such sub-codes as time information and program information, item 7 is a data recording area for recording a compressed digital video signal, items 2 and 6 are preambles for the respective recording areas, items 4 and 8 are postambles for the respective recording areas, item 5 is a gap between the respective recording areas, and items 1 and 9 are margins at the edges of the tape. By providing the recording areas with postambles, preambles, and a gap, in this way, those respective areas can be independently accessed after being recorded. A digital signal other than a compressed digital video signal may of course be recorded in the recording area 7. The data recording area 7 is configured of a plurality of blocks (which are to be distinguished from the blocks described earlier which are encryption units) FIG. 10 is a diagram of a block in the data recording area 7 shown in FIG. 9. Item 20 is a synchronization signal, item 21 is ID information, item 22 is data, and item 23 is first parity (C1 parity) for detecting and correcting an error. One block is configured of 112 bytes, with the synchronization signal 20 made up of 2 bytes, the ID information 21 of 3 bytes, the data 22 of 99 bytes, and the parity 23 of 8 bytes, for example.

FIG. 11 is a diagram of the ID information 21 indicated in FIG. 10. Item 31 is a group number, item 32 is a track address, item 33 is a block address inside one track, and item 35 is parity for detecting an error in the group number 31, track address 32, and block address 33. The block address 33 is an address for identifying a block in the recording areas. In the data recording area 7 shown in FIG. 9, for example, that block address 33 is 0 to 335. The track address 32 is an address for identifying a track. The address is changed in 1-track or 2-track units, for example, and n tracks can be identified. By making this 0 to 5 or 0 to 2, for example, six tracks can be identified. By changing the group number 31 in FIG. 11 in 6-track units identified by the track address 32, and making it 0 to 15, 96 tracks can be identified. If the track address 32 is synchronized with the period of a second error correction code, described subsequently, then processing when recording and identification when reproducing can be made easy.

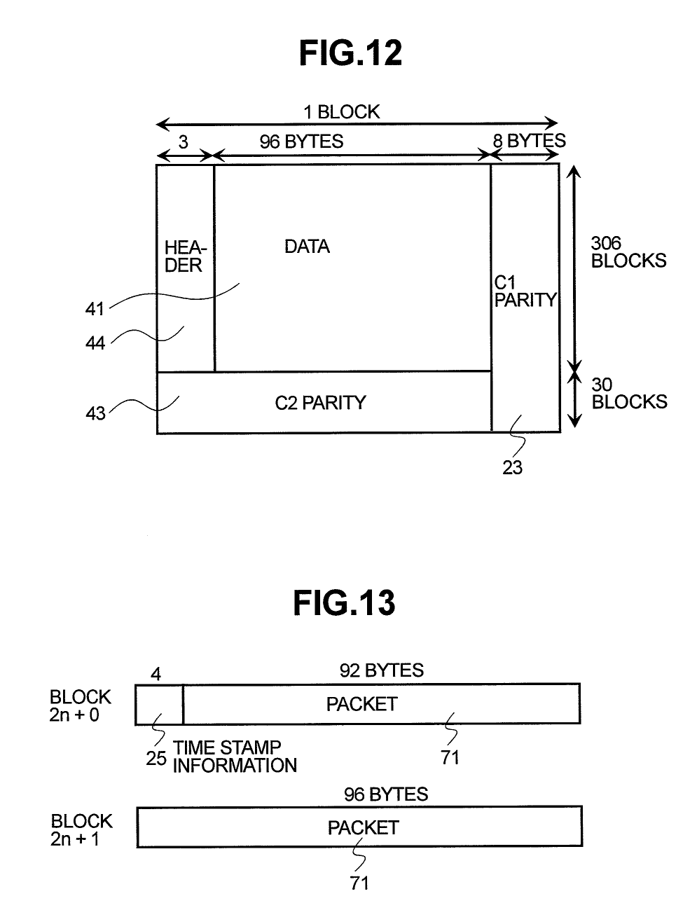

FIG. 12 is a diagram of one track of data in the data recording area 7 shown in FIG. 9. Here, the synchronization signal 20 and ID information 21 indicated in FIG. 10 have been omitted. The data recording area 7 is configured of 336 blocks, for example. Data 41 are recorded in the first 306 blocks and a second error correction code (C2 parity) 43 is recorded in the next 30 blocks. The C2 parity 43 is configured in n-track units, such as 6-track units, for example. Considered in 6-track units, the data are 306 blocks×6 tracks of data. Those data are divided into 18 parts, and to each respective 102 blocks, there are added 10 blocks of C2 parity. For the error correction code, a Reed Solomon code may be used, for example. The 99 bytes of data in each block are configured of a 3-byte header 44 and 96 bytes of data 41.

FIG. 13 is a diagram showing the configuration of blocks in one packet when a compressed digital video signal transmitted in a 188-byte packet format is recorded in the data 41 indicated in FIG. 12. In this case, 4 bytes of time stamp information 25 are added to make 192 bytes, and one packet is recorded in two blocks. The time stamp information 25 is information on the time a packet was transmitted. More specifically, the time when the head of a packet was transmitted or the interval between packets is counted with a reference clock signal, that count value is recorded together with the packet data, and the interval between packets is set, based on that information, when reproducing data. When that is done, data can be output in the same interval as when transmitted.

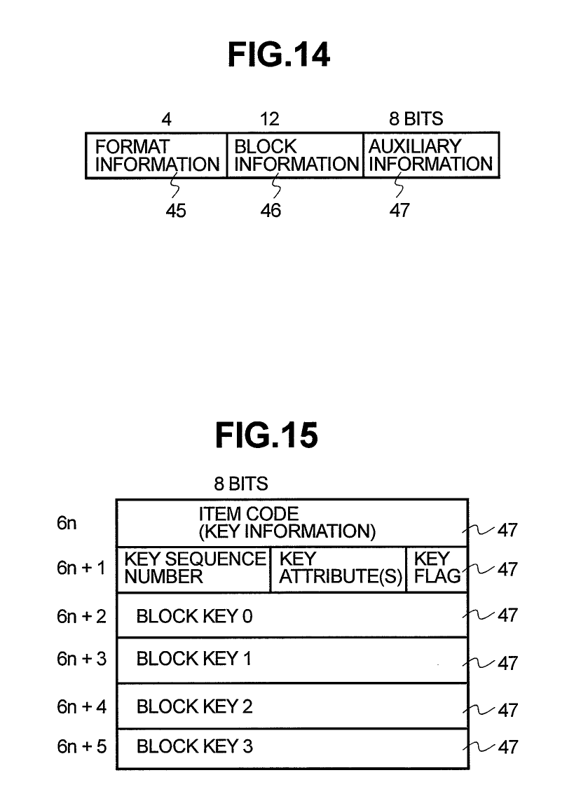

FIG. 14 is a diagram of the header 44 in the data recording area 7 shown in FIG. 12. This header 44 is configured of format information 45, block information 46, and auxiliary information 47. In the format information 45 and block information 46, there are recorded various kinds of recording information relating to recording, while in the auxiliary information 47, there is recorded other supplemental information.

The format information 45 is information relating to the recording format, and it configures one item of information with multiple blocks, containing the recording mode identifying a standard speed mode and other things), the type of packet data handled, and copy control information indicating whether or not the packet data recorded can be copied, etc. One item of information is configured in 12 bytes of 12 blocks, for example. By repeating this information a plural number of times and multiply recording it, moreover, the detection capability when reproducing is enhanced. It is also possible to record the key information and the like described earlier here.

The block information 46 is information for identifying the type of data recorded in the data recording area 41. Here, indications are recorded as to whether or not there are high-speed variable-speed reproducing data and the type thereof (indicating to which speed the high-speed variable-speed reproducing data correspond to), etc. It is also possible to record the key information and the like described earlier here.

The auxiliary information 47 configures pack data that comprise one item of information in 6 bytes of 6 blocks. By making the first byte an item code representing the information type, and the remaining 5 bytes data, various kinds of data can be recorded. Key information, such as the block key described earlier, or other information such as information on recording time and the like, or the type of recording signal or the like, for example, can be recorded here.

FIG. 15 is a diagram of a configuration for pack data when block keys are held in the added information 47 area indicated in FIG. 14.

In the first byte of the pack data, there is held an item code indicating that the information which follows is key information.

In the second byte, information indicating the type of key that is held (key sequence number, key attribute, or key flag) is recorded. As described earlier, the security of the data on the recording medium can be enhanced by successively yang the block key at some time interval, wherefore, key attribute information is recorded to indicate whether the block key held in this pack is the block key used in encrypting the current packet data or the block key to be used next. Also, the switching timing is recorded with a key flag that reverses every time the block key is updated. With this information, the switching of keys when reproducing is made smooth. In the key sequence number, moreover, when the block key cannot be held in one pack, information is held which indicates that there is a following pack. When the block key is 96 bits, for example, it is divided and held in 3 packs, with 2, 1, and 0, respectively, held in each key sequence number, where the 0 indicates that that is the last pack. In addition, there is also the method of storing the size of all the data so that the size of what remains may be known.

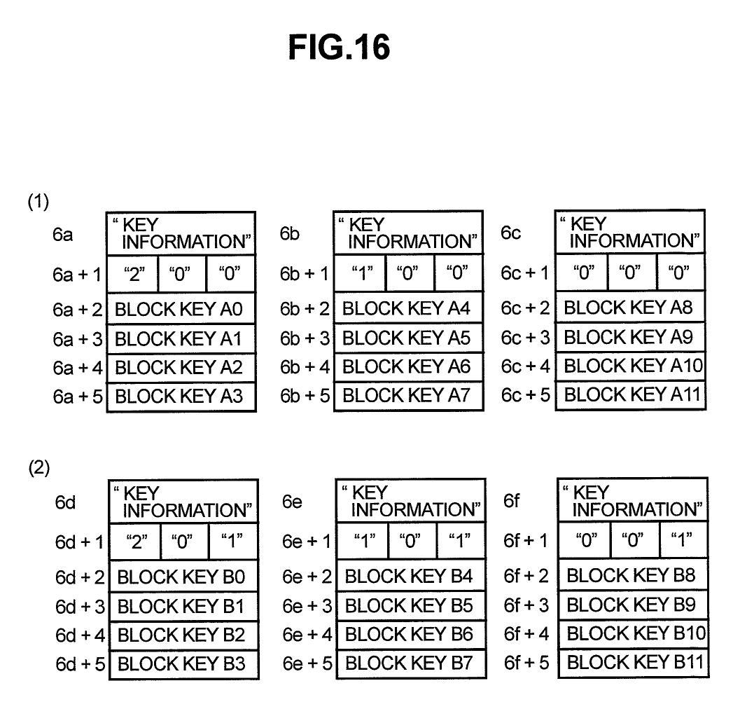

The block key is contained from the 3rd to the 6th byte. In the example shown in FIG. 8(b), as described earlier, the key information Kp is held instead of the block key. FIG. 16 is a diagram of a block key holding method. In the case represented in this example, only the current key information is recorded in the pack data in each track. Accordingly, the key attribute described earlier is fixed information that only indicates the current key, and need not be recorded. In (1) in FIG. 16, a condition where a 96-bit current block key A (A0 to A11) is divided and held in three packs is shown. Ordinarily, these packs are recorded a plurality of times, for one track, in order to enhance data reliability. By recording three packs in a first, middle, and last area, respectively, in a track (a total of 9), for example, the effects of reproducing signal dropouts caused by magnetic head clogging and the like can be reduced. Also, there is no absolute necessity of recording three packs as consecutive packs, but, by inserting packs holding other information between packs, and recording the packs holding the key information so that they are dispersed, it becomes possible to protect the key information itself and further enhance reliability. At (2) in FIG. 16, pack data recorded in a track where the block key has been switched to B is shown. In this case, the key flag for the block key B is reversed.

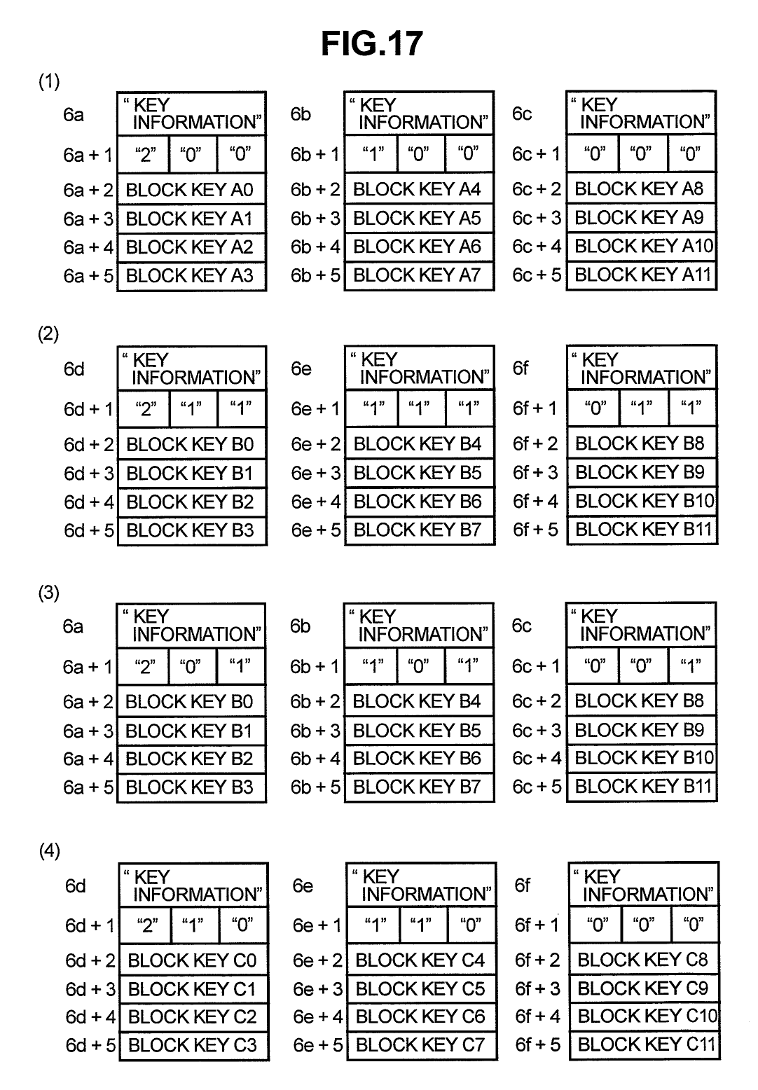

FIG. 17 is a diagram of another block key holding method. In the method represented in FIG. 17, the key information to be used next is pre-generated and recorded along with the current key information. Here, the key attribute information is “0” for a block key that is being used in encrypting the current packet data and “1” for the block key that will be used next. Also, the key flag that reverses every time the block key is updated alternates repeatedly between “0” and “1”.

In (1) in FIG. 17, a condition is shown in which a 96-bit current block key A is held. In (2), the next block key B is held. The information (1) and (2) here are recorded in the added information area in a block in the same track. In (3), pack data are recorded in a track where the block key has been switched to B. In this case, the block key B has reverted to the current key having key attribute information “0,” and the key flag is also reversed. And, in (4), the key C to be used next is held. The information (3) and (4) are recorded in a track as pack data in the same track.

In terms of the location where the key flags are held that indicate block key update timing, instead of holding those in an added information 47 pack, there is the method of holding them in the format information 45 or block Information 46 shown in FIG. 14, as described earlier.

As noted earlier, the key information is recorded on the tape. However, by using the points of separation between each n tracks (6 tracks in this embodiment) that is the unit for adding the C2 parity described earlier for the timing wherewith the block key is switched, C2 parity operations become possible, when reproducing data, and the data reliability of key information is enhanced.

In the example described in the foregoing, moreover, information indicating the timing wherewith the block key is updated is recorded as a key flag. However, by synchronizing the C2 parity operation period and update timing with the value of the track address 32 or group number 31 indicated in FIG. 11, and is described earlier, in the recording signal processing circuit 102a indicated in FIG. 2, it is possible also to detect the key information update timing when reproducing data with the value of that track address 32 or group number 31. In the recording signal processing circuit 102a, for example, the track address 32 repeats the values of 0 to 5 for each track, and the 6 tracks of those values 0 to 5 comprise the unit of adding the C2 parity described earlier. Then, with timing wherewith the value goes from 5 to 0, in the data encryption circuit 115, the block key is updated and recorded. When reproducing data, it is only necessary to detect the timing wherewith the value of that track address 32 goes from 5 to 0, in the reproducing signal processing circuit 102b shown in FIG. 2, and to go on updating the key in the data decryption circuit 116. Also, in cases where an update is done with an even longer period, it is possible to detect the update timing in 96-track units, and at the points of separation between the units wherewith the C2 parity is added, using the group number 31, by incrementing the group number 31, when the value of the track address 32 goes from 5 to 0, making provision so that the values from 0 to 15 are repeated.

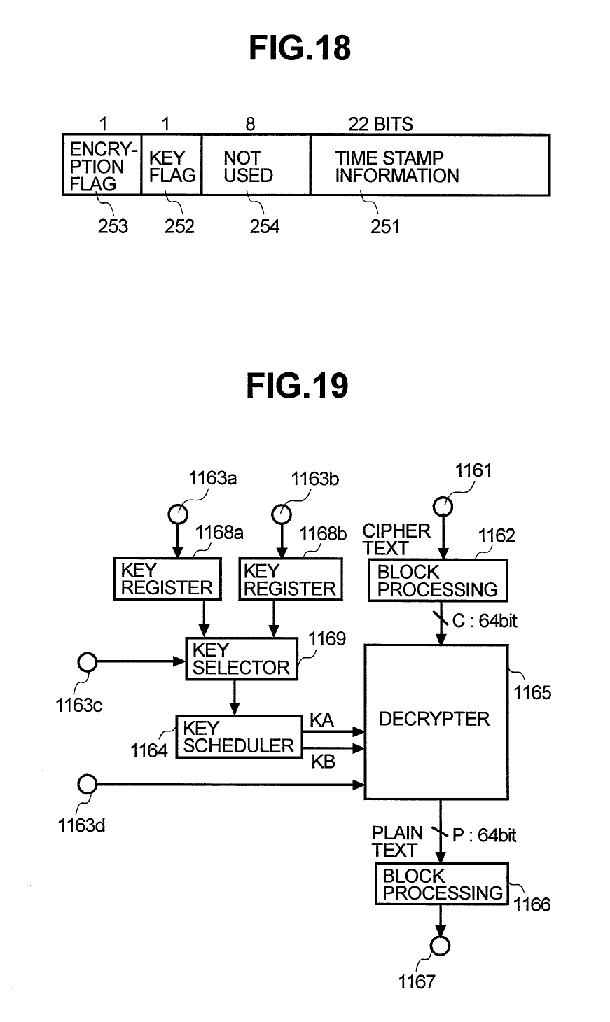

FIG. 18 is a diagram showing a specific configuration for the time stamp information 25 (4 bytes=32 bits) of FIG. 13, representing another method for holding a key flag and encryption flag. In the example illustrated here, the time stamp information 251 is 22 bits of information, item 252 is the key flag (1 bit) described earlier, and item 253 is a encryption flag (1 bit) indicating whether the following packet data are encrypted or not. When recording data, the input/output control circuit 119 shown in FIG. 2, together with time stamp information 251 that is a time stamp, places a “1,” for example, in the encryption flag 253 when the following packet data are encrypted, and a “0” therein when not encrypted; and, in the key flag 252, it places the key flag for the pack data holding the key information described earlier that corresponds to the following packet data. When reproducing data, in the input/output control circuit 119 of FIG. 2, the time stamp information 25 added when recording is removed and output to the data decryption circuit 116, and; together therewith, the encryption flag 253 and the key flag 252 are sent to the data decryption circuit 116, and the operation of the data decryption circuit 116 is controlled.

FIG. 19 is a configurational diagram of the data decryption circuit 116 shown in FIG. 2, which comprises a packet data input terminal 1161, a packet data output terminal 1167, data key input terminals 1163a and 1163b, a data key selection signal input terminal 1163c, a processing mode selection signal input terminal 1163d, block processing circuits 1162 and 1166, a key schedule circuit 1166, a decrypted 1165, data key registers 1168a and 1168b, and a data key selector 1168. The data decryption circuit 116 decrypts, and outputs data, in units of the packet data input, using predetermined data keys.

The decrypter 1165 uses block cipher to effect decryption processing in units of blocks configured of multiple bits.

The packet data input from the input terminal 1161 are divided into blocks C made up of multiple bits, in the same manner as with the data encryption circuit 115. The blocks are sequentially decrypted in the decrypter 1165, as a result whereof blocks P are output; and then, in the block processing circuit 1166, the blocks are restored to the packet data format and output to the output terminal 1167. Here, the data keys that are keys for performing decryption, from the control circuit 104, are input from the data key input terminals 1163a and 1163b, and stored in the data key registers 1168a and 1168b. In the data key register 1168a, for example, the current data key is recorded, and in the data key register 1168b the next data key to be switched is recorded.

Furthermore, from the processing mode selection signal 25 input terminal 1163d, the detected encryption flag 253 from the input/output control circuit 109 is input, and either a mode for a decrypting operation or a mode for passing the data without doing anything is determined. From the data key selection signal input terminal 1163c, moreover, the detected key flag 252 is input from the input/output control circuit 109, and the selected data key is output by the data key selector 1169. The selected data key is converted in the schedule circuit 1164 to sub-keys KA and KB and sent to the encrypter 1165.

Here, when the encryption flag or key flag detected by the input/output control circuit 119 shown in FIG. 2 changes, in conjunction therewith, the operating mode of the data decryption circuit 116 and the data key are selected.

As described in the foregoing, by adding the encryption flag or key flag to the packet data, whether or not encryption has been done, and key information, can be determined, and decryption processing effected, in packet data units.

In terms of the location where the encryption flag indicating whether or not encryption has been done is held, there is a method of holding that in the second byte in the pack holding the key information shown in FIG. 15, and, alternatively, the method of holding it in the format information 45 or block information 46 shown in FIG. 14, as described earlier.

By holding the encryption flag in the format information 45 or block information 46 or the like, and making provision so that, when the encryption flag indicates “1,” for example, that is, when the packet data are encrypted, the operation of the data decryption circuit 116 is a decryption operation and so that key information is fetched from the pack holding the key information in the added information 47, and, when the encryption flag is “0”, so that the operation of the data decryption circuit 116 is such as to output data as is without decrypting, control operations when packet data are not encrypted can be simplified. With the method of holding the encryption flag in the pack holding the key information, moreover, when the encryption flag is “0,” that is, when the packet data are not encrypted, block key information from the third byte on in that pack is not held.

In addition, whether or not encryption has been performed can be determined by whether or not there is a pack holding key information, for example, without using the encryption flag.

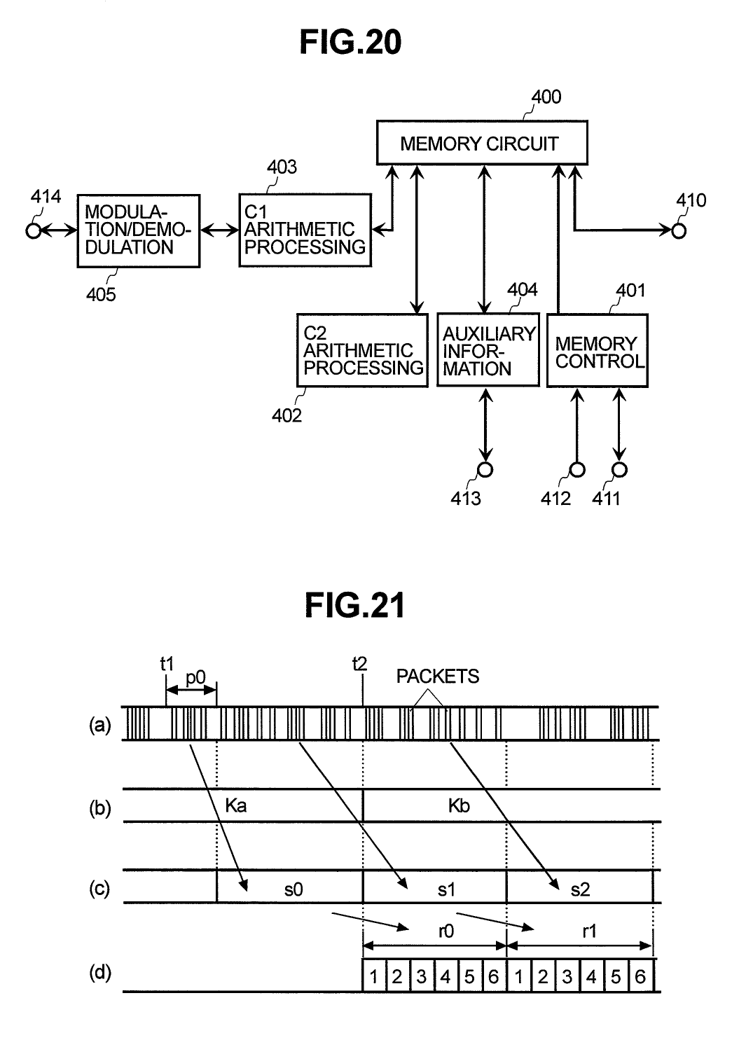

FIG. 20 is a diagram of a digital recording and reproducing signal processing circuit 102 that comprises the recording signal processing circuit 102a and the reproducing signal processing circuit 102b shown in FIG. 2. The circuit 102 comprises a memory circuit 400, a memory control circuit 401 for generating addresses and the like for controlling the memory circuit 400 in subordination to the control circuit 104 of FIG. 2, a C2 parity arithmetic processing circuit 402, a C1 parity arithmetic processing circuit 403, an auxiliary information processing circuit 404 for adding auxiliary information when recording, according to the content set from the control circuit 104, such as ID information, sub-code generation information, format information, block information, and key information, and for fetching auxiliary information when reproducing data, such as ID information, sub-code, format information, block information, and key information, etc., and a modulation/demodulation circuit 405 for performing modulation processing when recording and demodulation processing when reproducing data. In this embodiment, as one example, 6 tracks of data are required in order to perform a C2 parity operation, wherefore the memory circuit 400 is to have sufficient capacity to store at least 6 tracks of data.

When recording data, a recording state is set via the terminals 411 and 413 by the control circuit 104 shown in FIG. 2. The packet data encrypted by the data encryption circuit 115 indicated in FIG. 2 are input from the terminal 410 and accumulated in the memory circuit 400 in accordance with control signals from the memory control circuit 401. After the data required for the C2 parity operation have been accumulated, they are sequentially read out from the memory circuit 400 and input to the C2 parity arithmetic processing circuit 402, and the prescribed arithmetic operation is performed. The operational results obtained by the C2 parity arithmetic processing circuit 402 are accumulated in the memory circuit 400. Meanwhile, in the auxiliary information processing circuit 404, in accordance with settings from the control circuit 104 via the terminal 413, packet data such as key information corresponding to the key of the input encrypted packet data are generated and accumulated in the memory circuit 400. Then, when configuring the recording blocks as described earlier, the data is read out from the memory circuit 400 containing the key information and the like have C1 parity added thereto by the C1 parity arithmetic processing circuit 403 and input to the modulation/demodulation circuit 405. The signal, subjected to prescribed modulation processing by the modulation/demodulation circuit 405, is output via the terminal 414, and is recorded on the tape 111 by the rotary head 100 as shown in FIG. 2. FIG. 21 is a timing chart for signal processing when data recording is started. Packet data input from the data encryption circuit 115 is shown in FIG. 21 at line (a), the data key used by the data encryption circuit 115 when encrypting is shown in FIG. 21 at line (b), the 02 parity operation cycle (6 tracks in this embodiment) performed by the C2 parity arithmetic processing circuit 402 indicated in FIG. 20, together with the six-track unit configuration of the C2 parity 43 described earlier, is shown in FIG. 21 at line (C), and the recording signal-recorded through the rotary head 100 onto the tape 111 is shown in FIG. 21 at line (d). In the embodiment shown in FIG. 21, the block key A is generated beforehand, and the data key Ka is calculated and sent to the data encryption circuit 115, prior to the time t1 for which recording start is set. Control is also effected so that, prior to the time t1 for which the recording start is set, the recording signal processing circuit 102a judges that there is no packet, irrespective of the input signal, and perform recording signal processing. Thus, even when the recording start is set to the time to, it will be possible to perform C2 parity operations on the data in the time period p0. The control circuit 104 shown in FIG. 2 effects control so that the C2 parity operation cycle S0 for the data input when recording started at time to ends, and the recording signal is output from the head of n tracks (6 tracks in this embodiment) that configure the second error correction code noted earlier (FIG. 21 at line (d)). The data key, moreover, is updated in this C2 parity operation cycle. For example, the block key B is generated prior to time t2, the data key Kb is calculated and sent ahead to the data encryption circuit 115, and, at time t2, the data key is switched to Kb in the data encryption circuit 115. Ordinarily, in the data encryption circuit 115, in order to perform that process, a delay time occurs from the input of the packet data to the output thereof. That being the case, at a point in time that is earlier by the measure of the data delay that occurs from the time t2 due to the packet encryption processing performed by the data encryption circuit 115, the data key sent to the data encryption circuit 115 is switched to Kb. Alternatively, data from the packet data for which the data key was switched may be sent ahead to the processing in the next arithmetic operation cycle. In this embodiment, extra data are recorded in the head portion, but C2 parity can be added to the signal to be recorded, irrespective of the timing at time t1 at which recording is to start, and recording done in units of the C2 parity operation cycle described above. When reproducing, moreover, the extra data portion at the head will only be used in the C2 parity calculation, and is never output, because recording processing is performed while assuming no packet.

When recording of data is finished, the recording of data to the tape 111 of the recording signal processing circuit 102a is controlled by the control circuit 104 so that it is performed at the completion of the arithmetic operation cycle (6 tracks in this embodiment) for calculating the C2 parity using multiple track data. With this control scheme, irrespective of the recording start and recording end switching timing, C2 parity is added to all recorded data on the tape 111, and key information is updated and the packet data are encrypted in C2 parity operation cycle units, wherefore, when reproducing data, reproduction can be done in C2 parity operation cycle units, and C2 parity calculations become possible, wherefore the key information data reliability is enhanced also.

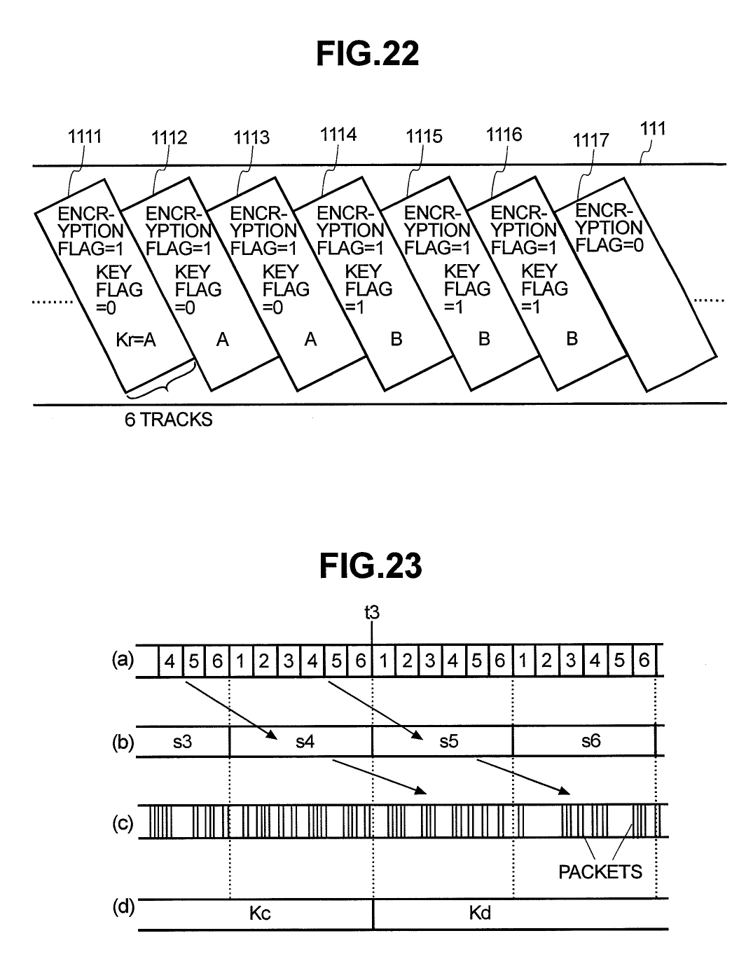

FIG. 22 is a diagram of key information on the tape 111 of FIG. 2. In this figure, items 1111 to 1117 are recording tracks represented in units of 6 tracks, which is the C2 parity operation cycle. In the case illustrated in FIG. 22, recording tracks 1111 to 1113 hold packet data encrypted using the block key A and recording tracks 1114 to 1116 hold packet data encrypted using the block key B, together with pack data that constitute key information corresponding thereto, respectively. The recording track 1117 is a track that is recorded without being encrypted. It is possible to have tracks that are encrypted and tracks that are not encrypted mixed together on the same tape, as shown here. It is conceivable that a key information update be performed once every m×n tracks (where m is an integer 1 or greater and n, in this embodiment, is 6), such as every 48 tracks or every 96 tracks, or, alternatively, for one entire program or the like. However, the point of key switching, or the boundary between an encrypted track and an unencrypted track, is the point where C2 parity operation cycles (6 tracks in this embodiment) are separated.

The operations when recording have been described in the foregoing. It is also possible here to record key information in the sub-code areas (7 in FIG. 9). However, when key information is held in the header (44 in FIG. 12) portion of each block and recording is carried out in the data recording areas (7 in FIG. 9) on the tracks, it becomes very difficult to rewrite only the key information by dubbing or the like. That being so, a loss of key information can be prevented, and a benefit is gained in that deliberate efforts to alter only the key information and intentionally perform cryptic cation cannot succeed.

Next, the method of reproducing data from a tape will be described.

In the digital recording and reproducing signal processing circuit 102 shown in FIG. 20, when reproducing data, a reproducing state is set by the control circuit 104 of FIG. 2 via the terminals 411 and 413. The reproducing signal that is reproduced from the tape 111 by the rotary head 100 and input from the terminal 414 is subjected to demodulation processing by the modulation/demodulation circuit 405, then it is subjected to a C1 parity operation by the C1 parity arithmetic processing circuit 403, whereupon the detection and correction of errors are performed, and the results of the C1 parity operation also are accumulated together in the memory circuit 400. After the data required for the C2 parity operation have been accumulated, the data are sequentially read out from the memory circuit 400, in accordance with control signals of the memory control circuit 401, and input to the C2 parity arithmetic processing circuit 402. In the C2 parity arithmetic processing circuit 402, arithmetic operations are performed with the data noted above, and the data that have been subjected to error detection and correction processing are again accumulated, together with the results of the C2 parity operation, in the memory circuit 400.

Data are read out from the memory circuit 400 in a prescribed order, referenced to a timing signal input via the terminal 412 from the timing generator circuit 105 shown in FIG. 2, the C1 parity and C2 parity operation results described earlier are referenced, and only errorless data are output from the terminal 410 to the input/output control circuit 119. In the auxiliary information processing circuit 404, meanwhile, key information and sub-codes and the like are acquired from data read out from the memory circuit 400 and are sent via the terminal 413 to the control circuit 104 of FIG. 2. Then, the operations shown in FIG. 8 are performed, that is, Kp is extracted from the key information obtained by generation, the exclusive-or operation with the device key obtained from the device key generator 117 is performed, the operation of the bash function arithmetic processor 121 is performed, and a data key is obtained and output to the data decryption circuit 116 shown in FIG. 2. This data key is identical to the data key used when recording, and therewith, in the data decryption circuit 116, the original packet data can be obtained accurately.

FIG. 23 is a timing chart for signal processing when reproducing data in accordance with the present invention. A reproducing signal-reproduced from the tape 111 via the rotary head 100 is shown in FIG. 23 at line (a), the C2 parity operation cycle (6 tracks in this embodiment) described earlier is shown in FIG. 23 at line (b), packet data output from the input/output control circuit 119 is shown in FIG. 23 at line (c), and a data key sent to the data decryption circuit 116 illustrated in FIG. 2 is shown in FIG. 23 at line (d). In the auxiliary information processing circuit 404, in the operation cycle s3, the key information Kpc used in this cycle is detected. By this information Kpc, the data key Kc obtained by the operation described earlier is stored in the data key register 1163a described earlier, for example, and the data key selector 1169 is also selected so that the data key Kc in the data key register 1163a is output.

Next, in the operation cycle s4, when it is detected that the key information KpD is being used, a data key Kd is derived ahead of time, by the previously described operation, and stored in the data key register 1163b, and, timed to the time t3, the data key selector 1169 is operated and the data key Kd in the data key register 1163b is switched to. Using the method described above, it is possible to perform a reproducing operation while updating the data key.

Furthermore, when making an additional recording to an already recorded tape, by ensuring that the recording is started from a point of separation between C2 parity addition units, an add-on recording is made possible without impairing the data reliability of the track key information immediately prior to the additional recording.

Besides that, in term of a method of distinguishing whether or not packet data have been encrypted, because the synchronization byte 501 indicated in FIG. 4 ordinarily consists of fixed data, that synchronization byte may be detected in the reproducing signal processing circuit 102b, for example, and, when the synchronization byte can be detected, the data decryption circuit 116 shown in FIG. 2 is switched to a function that passes packet data input thereto without doing anything to it, but, when the synchronization byte cannot be detected, the data decryption circuit 116 of FIG. 2 is switched to a decryption function operation and performs an operation to detect key information in the added information area. By so doing, when recording data, detection will be possible, even with tape wherein tracks on which packet data are encrypted and recorded and tracks on which packet data are recorded without being encrypted coexist together.

Furthermore, even with prerecorded software tape, the production and reproducing of software tape is made possible with the method described in the foregoing, and the protection of packet data on such tape can be realized.

In the examples described in the foregoing, the current block key is held in a recording track, but the data key calculation must be performed in a single C2 arithmetic operation cycle. In a case where the data key calculation cannot be done quickly enough, within a single C2 arithmetic operation cycle, then, by recording the current block key and the next block key in a recording track, as described earlier, the next data key will be found ahead of turn.

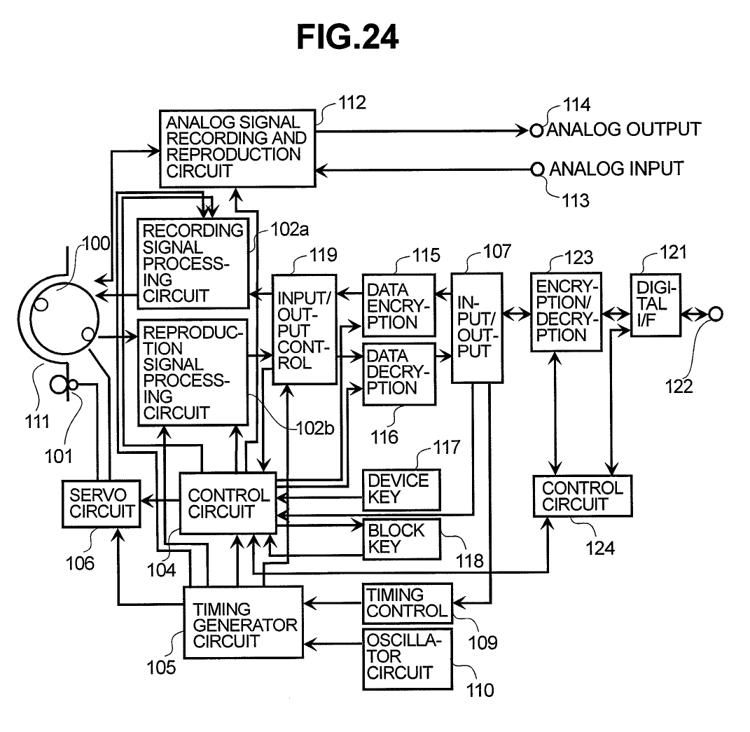

FIG. 24 is a diagram of another configuration of the digital signal recorder-reproducer 200 indicated in FIG. 1. In this figure, item 121 is a digital interface circuit that effects a protocol, such as a high-speed digital bus interface, such as IEEE 1394, for example. This digital interface circuit 121 has functions for transmitting data at high speed, while maintaining the time intervals in the input packet data. Item 122 in FIG. 24 is a digital interface bus. Item 123 is an encryption/decryption circuit for protecting digital data transmitted over the digital interface 122. This circuit 123 either encrypts packet data and transmits those encrypted data over the digital interface bus 122, or decrypts received digital data. Item 124 is a control circuit, such as a microprocessor, for controlling the digital interface circuit 121 and the encryption/decryption circuit 123.

When recording data, encrypted digital data that come in over the digital interface bus 122 are subjected to prescribed packet processing in the digital interface circuit 121, then, in the encryption/decryption circuit 123, this data is decrypted to the original packet data and output to the input/output circuit 107. After that, as described earlier, the packet data are encrypted in the data encryption circuit 115 and recorded on the tape 111. When reproducing data, in the data decryption circuit 116, reproduced packet data are decrypted, output from the input/output circuit 107 to the encryption/decryption circuit 123, encrypted in the encryption/decryption circuit 123, and output from the digital interface circuit 121 to the digital interface bus 122. Based on this, the protection both of packet data on a tape and of packet data on a digital interface bus can be realized.

In the embodiment described in the foregoing, moreover, recording data on and reproducing data from a tape are described, but the present invention can be similarly applied when recording data on and reproducing data from a disk, such as an optical disk or magnetic disk, a semiconductor memory or the like, or any other recording medium.

In the case of the disks noted above, key information switching, or switching to determine whether or not to perform encryption, may be performed at the points of separation between sectors, which are one unit of recording on a disk.

Also, in the case of the semiconductor memory noted above, key information switching, or the switching to determine whether or not to perform encryption, may be performed at the points of separation between addresses, which are one unit of recording on a semiconductor memory.

This embodiment, moreover, is one that is applied to a system for encrypting a digital signal using a key. The present invention is not limited to or by this embodiment, however, and can be applied also to systems wherein a digital signal is scrambled or the like using a key code. In other words, the present invention can be applied to all systems wherein a digital signal is processed so that it is converted from its original clear state.

According to the present invention, in a digital signal recorder, reproducer, and recording medium, with which recording is performed on or reproducing is carried out on the recording medium, when recording data, key information is subjected to a prescribed operation to yield a key, and the digital signal is encrypted and recorded together with the key information onto the recording medium; whereas, when reproducing data, the key information reproduced from the recording medium is subjected to the prescribed operation, and, with the key obtained thereby, the reproduced digital signal is decrypted and output. Based on the foregoing, when reproducing data, so long as the prescribed operation is not performed, the key cannot be obtained. Therefore, even though the key information on the recording medium may be obtained, it is very difficult, using that information, to decrypt the encrypted digital signal. Thus, the copyrights of the digital data on the recording medium can be protected.

What is claimed is:

1. A digital signal recorder for recording a digital signal on a recording medium, comprising:
an input circuit which receives a transmitted digital signal encrypted for protecting said transmitted digital signal using a first encryption method;
a decrypting circuit which decrypts said transmitted digital signal into an original data;
a key generation circuit which performs a prescribed arithmetic operation to generate a key;
an encrypting circuit which receives said key and said original data, and encrypts said original data with said key using a second encryption method;
a recording circuit which records, onto said recording medium, a key information which is used for decrypting said encrypted digital signal together with said encrypted digital signal, and
a timing control circuit which controls decrypting timing of said decrypting circuit and encryption timing of said encrypting circuit;
wherein said key generation circuit has a function for updating said key in connection with recording units of said recording media.

2. The digital signal recorder according to claim 1,
said key generation circuit has a function for updating said key at a prescribed length interval.

3. The digital signal recorder according to claim 2, wherein:
said digital signal has a packet format of a prescribed length; and
said recording circuit has a function for adding identifying information indicating where said key is updated, to packets of said digital signal recorded on said recording medium.

4. The digital signal recorder according to claim 3, wherein:
said recording circuit has a function for adding encryption flag information indicating whether said digital signal is encrypted or not, to packets of said digital signal recorded on said recording medium.

5. The digital signal recorder according to claim 3, wherein:
said recording medium is a removable recording medium.
